(19) United States
(12) Patent Application Publication
(10) Pub. No.: US 2017/0323367 A1
(43) Pub. Date: Nov. 9, 2017

(54) RETAIL PRODUCT ASSORTMENT OPTIMIZATION SYSTEMS AND METHODS

(71) Applicant: Wal-Mart Stores, Inc., Bentonville, AR (US)

(72) Inventor: Bruce CROW, Bentonville, AR (US)

(21) Appl. No.: 15/585,536

(22) Filed: May 3, 2017

Related U.S. Application Data
(60) Provisional application No. 62/332,218, filed on May 5, 2016.

(51) Int. Cl. G06Q 30/06; G06F 17/30

(52) U.S. Cl. CPC G06Q 30/0629; G06F 17/30864

(57) ABSTRACT

Embodiments relate to systems and methods for optimizing a product assortment available at a retail location based on the likelihood of products to meet customer needs. This can include obtaining a mass list of potential products from at least one publicly available source; collating the mass list into a plurality of customer needs addressable by the potential products; determining a number of the plurality of customer needs that are addressable by particular ones of the potential products and converting the number for each of the particular potential products into a score for the particular potential product, wherein a high score indicates a particular potential product addresses a high number of the plurality of customer needs; comparing the particular potential products having high scores with a retail assortment product list for at least one location; and updating the retail assortment at the at least one location to include at least one of the particular potential products having a high score based on the comparing.

### RELATED APPLICATION

The present application claims the benefit of U.S. Provisional Application No. 62/332,218 filed May 5, 2016, which is hereby incorporated herein in its entirety by reference.

### TECHNICAL FIELD

Embodiments relate generally to inventory management and more particularly to systems and methods for optimizing a product assortment available at a retail location based on the likelihood of products to meet customer needs.

### BACKGROUND

Increasingly, retailers desire to customize product assortments in particular stores to meet their customers' needs and preferences. For example, a customer in an urban area may have different shopping needs than a customer in a rural area, and suburban stores may serve more families with children than an urban store in a commercial district.

Managing customer needs can be particularly challenging for retailers. Conventional approaches rely on backwards-looking or comparative sales data for existing products, without a way to evaluate new items to add. Adding one new product to a store could increase sales marginally, either because it is similar to other products already on offer or meets only a few customer needs, whereas another product, if added, could meet a wider variety of needs and therefore increase sales and customer satisfaction to a higher degree. Identifying the latter type of product by considering customer needs it would meet is a significant challenge not met by conventional approaches.

### SUMMARY

In an embodiment, a method of optimizing a retail assortment comprises obtaining a mass list of potential products from at least one publicly available source; collating the mass list into a plurality of customer needs addressable by the potential products; determining a number of the plurality of customer needs that are addressable by particular ones of the potential products and converting the number for each of the particular potential products into a score for the particular potential product, wherein a high score indicates a particular potential product addresses a high number of the plurality of customer needs; comparing the particular potential products having high scores with a retail assortment product list for at least one location; and updating the retail assortment at the at least one location to include at least one of the particular potential products having a high score based on the comparing.

In an embodiment, a system for optimizing a retail product assortment comprises a data scraping and processing engine configured to obtain a mass list of potential products from at least one publicly available source; and a data processing engine communicatively coupled with the data scraping engine and configured to collate the mass list into a plurality of customer needs addressable by the potential products, determine a number of the plurality of customer needs that are addressable by particular ones of the potential products, convert the number for each of the particular potential products into a score for the particular potential product, wherein a high score indicates a particular potential product addresses a high number of the plurality of customer needs, and provide an output recommendation to a buyer associated with a retail location to update a product assortment at the retail location to include at least one of the particular potential products having a high score based on comparing the particular potential products having high scores with a product assortment list for the retail location.

### BRIEF DESCRIPTION OF THE DRAWINGS

Embodiments may be more completely understood in consideration of the following detailed description of various embodiments in connection with the accompanying drawings, in which:

FIG. 1A is a diagram of customer needs/problems and products that solve those needs/problems in accordance with an embodiment.

FIG. 1B is another diagram of customer needs/problems and products that solve those needs/problems in accordance with an embodiment.

FIG. 1C is a modified version of the diagram of FIG. 1B showing a result of removing one product from the assortment.

FIG. 2 is a flow diagram of developing a utility score according to an embodiment.

FIG. 3 is a block diagram of evaluating and updating a product assortment according to an embodiment.

While embodiments are amenable to various modifications and alternative forms, specifics thereof have been shown by way of example in the drawings and will be described in detail. It should be understood, however, that the intention is not to be limited to the particular embodiments described. On the contrary, the intention is to cover all modifications, equivalents, and alternatives falling within the spirit and scope of the appended claims.

### DETAILED DESCRIPTION

Retailers, whether they have traditional brick-and-mortar storefronts or online marketplaces (or both), offer an assortment of goods for sales. In some cases, the assortment also may include services. A retailer wants its assortment to meet as many of its customers' needs as possible, but identifying these needs and the products that meet them can be challenging.

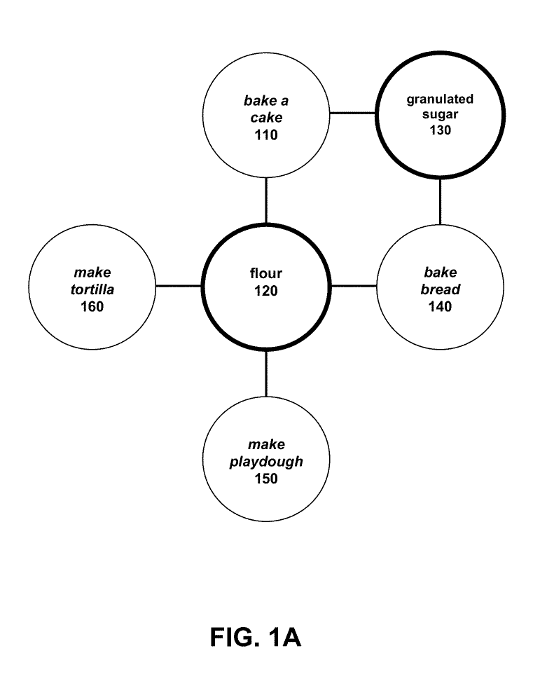

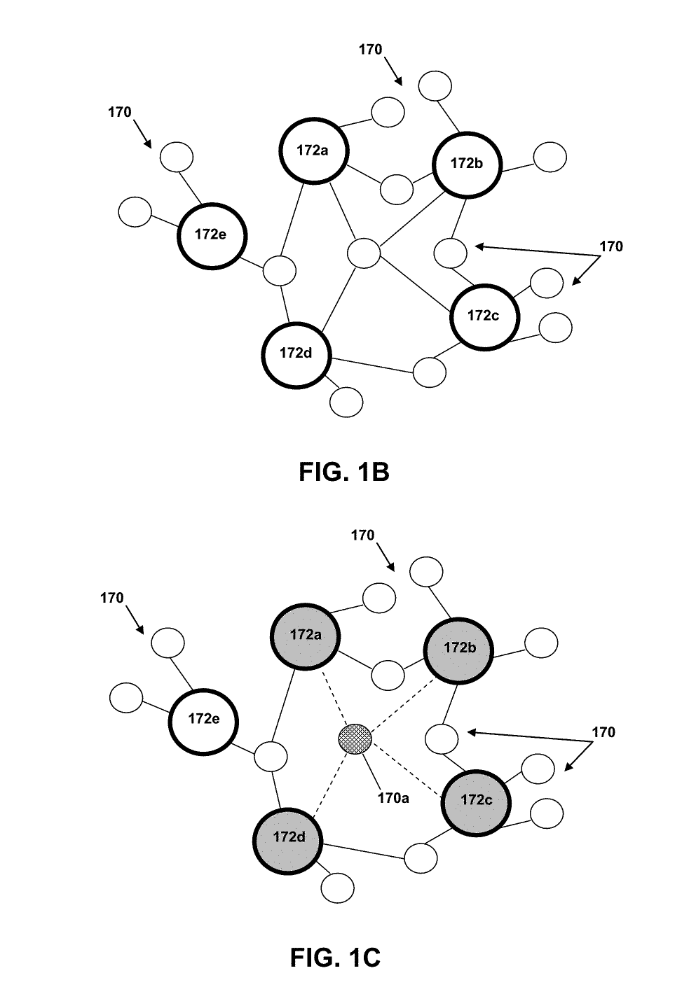

Many customer needs are driven by “problems” that they have. For example, and referring to FIG. 1A, a customer may decide to bake a cake 110 and realize the recipe calls for flour 120 and granulated sugar 130 that they do not have. Three additional example customer problems or needs are depicted in FIG. 1A: baking bread 140 (requiring flour 120 and granulated sugar 130); making playdough 150 (requiring flour 120); and making tortilla 160 (requiring flour 120). These examples are not exhaustive with respect to the ingredients or requirements for these particular problems (i.e., a bread recipe likely also requires yeast), but rather they are exemplary of problem-driven product needs that retail customers may have.

As can be seen in FIG. 1A, flour 120 meets many customer needs and therefore can be considered to have high utility. Granulated sugar 130 also may have relatively high utility because it, too, meets multiple problems; but the utility of granulated sugar 130, at least in this example, may be lower than that of flour 120 because it meets fewer needs.

Identifying products like flour 120, in particular, but also sugar 130, which solve multiple customer problems, is a retailer goal. Moreover, retailers would like to identify products like these that are not already stocked at a particular location, such that by adding a relatively small number of new products to the available product assortment the retailer is able to meet a relatively large number of customer needs. Utility scores can be extrapolated from individual products to product assortments, and adding individual products with high utility scores can improve the utility score of the product assortment at any particular retail location.

This can be seen in FIGS. 1B and 1C. FIG. 1B depicts a product assortment 170 that includes all of the products necessary to completely resolve five customer needs or problems 172a, 172b, 172c, 172d, 172e. Referring to FIG. 1C, if one product 170a is removed from product assortment 170, four customer needs 172a-d become unmet because product assortment 170 no longer includes each product associated with those needs 172a-d when product 170a is removed from assortment 170. With only one (172e) of five problems (172a-172e), the utility score of assortment 170 would fall from 100% in FIG. 1B to 20% in FIG. 1C. Looking at this from another perspective, if the current product assortment 170 at a retailer is that depicted in

FIG. 1C, adding one product 170a to assortment 170 increases the utility score of assortment 170 from 20% to 100%. In reality, a utility score of 100% may be practically impossible to obtain, but a goal for any retailer—and a goal of embodiments of the systems and methods discussed herein—is to identify and offer product assortments with optimized (i.e., high) utility scores to meet as many customer needs as possible. In other words, embodiments enable and consider quantification of value on a product-by-product basis, and assortment-wide, based on the number of problems each product is connected with and therefore partially or completely “solves.”

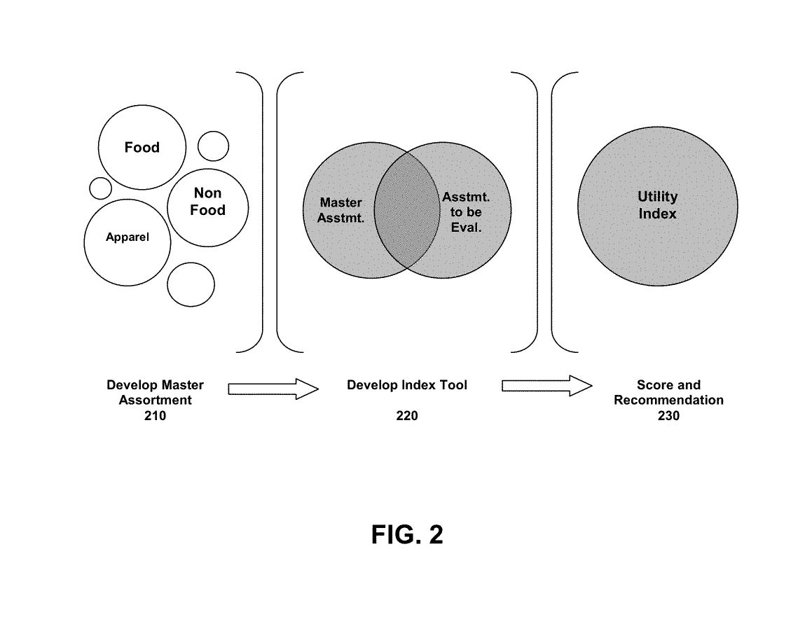

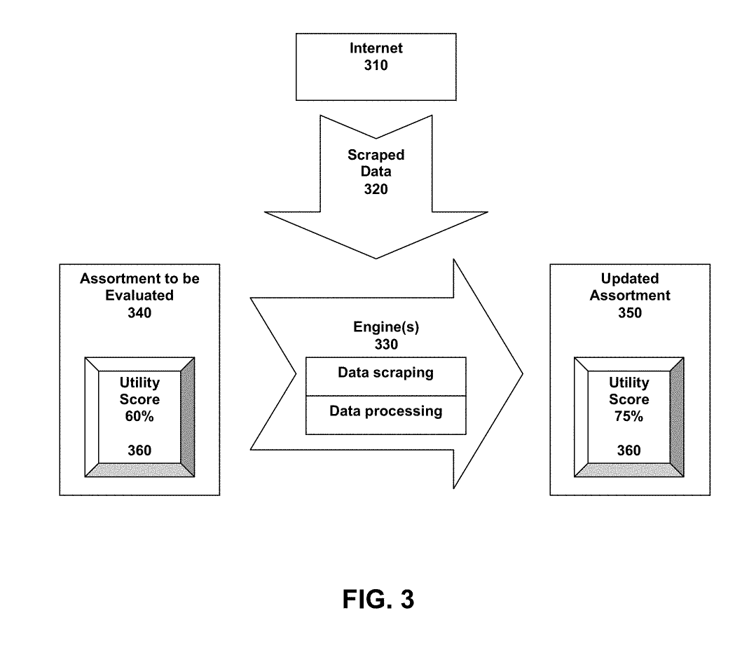

A task, then, is to identify customer problems or needs, and then products that solve those problems or needs. Referring to FIGS. 2 and 3, a master product assortment is developed at 210. Theoretically, the master product assortment includes every possible product that could meet a customer need or solve a customer problem. Practically speaking, the master product assortment is a large-scale assemblage of products that can solve customer problems, but it may not identify every product to solve every problem of every customer because of information access and availability; theoretically, however, this is the goal. In some situations, the master assortment may be limited to fit a retailer's scope. For example, a grocery retailer may not be interested in trying to meet customer apparel needs, and therefore developing a master assortment at 210 for that grocery retailer may intentionally exclude apparel and other product categories.

In one embodiment, developing a master assortment at 210 includes implementing large-scale data collection and scraping tools to collect data from publicly available sources, such as via the internet 310. These tools can scrape data 320 from recipes, parts lists, instruction sets and manuals, social media sites, project lists, patterns, supply lists, books, magazines, blogs, articles, and virtually any other source. In one embodiment these tools include a data scraping engine, which can be one or more of the engines 330 in FIG. 3. For example, a recipe for baking bread published on a cooking website includes a list of all of the ingredients and tools required; this can include flour, sugar, yeast, etc., as well as a loaf pan in which to bake the bread and a cooling rack on which to cool the bread after baking. An instruction set on a do-it-yourself website for installing a faucet can require the faucet kit, a wrench, a bucket, rags, and silicone caulk. A supply list on, e.g., PINTEREST, for a children's art project can include construction paper, glue, glitter, scissors, pipe cleaners, and markers.

A goal at 210 is to assemble and collate a huge volume of data 320 in order to identify as many potential customer problems/needs, and corresponding solutions, as possible. In some embodiments, this can be carried out by one or more analytics engines 330 executing data scraping and collating algorithms and techniques to obtain a mass list of potential products. In other embodiments, additional data scraping engines can be implemented in operation and/or communication with data processing and analytics engines of engines 330. This could be advantageous because the volume of data to be scraped and collated can be tremendous, outside the realm of what could be obtained manually by human users. Engines 330 are referred to collectively but can comprise disparate engines and/or computer systems in embodiments, or integrated engines and/or computing systems in other embodiments.

A result of 210 is an assembled master assortment of potential products, collated as solutions to customer needs/problems. This master assortment can be stored in a database of or communicatively coupled to engines 330. The assortment can include a tally of the total number of customer needs/problems that are addressed by the master assortment as well as a number of times each discrete product is called for in solving those problems. For example, in FIG. 1A, there are four needs/problems 110, 140, 150, 160 depicted, with flour 120 solving four needs/problems and sugar 130 solving two needs/problems. The more needs/problems a product addresses, the higher the value of that product (e.g., flour>sugar in the example of FIG. 1A).

Engines 330 can execute algorithms and implement techniques to collate the raw scraped data in this master assortment, for example in ways similar to as depicted in FIGS. 1-2. For example, engines 330 can use secondary words and terms to identify meaning (e.g., a supply list calling for “markers” could refer to any or all of: writing or coloring tools; plastic pieces used in needlecrafts to mark numbers of stitches; game pieces; or small stakes used in gardening to label planting areas or plants), and in embodiments the data scraping and collating algorithms can sort the solution with the proper need/problem. Over time, engines 330 can “learn” and become more sophisticated in order to determine which meaning is applicable from context, and can update the data scraping and collating algorithms accordingly. Because of the volume of data scraped and collated, user intervention may not be required or even desired, as previously mentioned, though in embodiments engines 330 can flag identified problems or solutions for manual review or confirmation. In still other embodiments, user definition of problems or solutions can be included, for example in situations in which a new problem is identified, a new solution becomes available, or the like. The need for manual intervention can be reduced by setting up a schedule for updated scraping and collating to ensure new problems and new solutions are identified and considered.

At 220, an index tool for determining utility scores is developed. In one embodiment, this is done by comparing the master assortment with an assortment to be evaluated. The assortment to be evaluated can be the current product assortment 340 available at a retail location, a proposed product assortment, or some other product assortment. As depicted in FIG. 2, generally there will be some overlap between the master assortment and the evaluated assortment already, and a goal can be to maximize this overlap. In other embodiments, a new assortment can be formulated from the master assortment, rather than by comparing an existing or proposed assortment therewith.

A utility score is provided at 230 as a result of the activity at 220. This utility score relates to the assortment to be evaluated with respect to the master assortment. For example, assortment to be evaluated 340 has a utility score of 60%, meaning it meets 60% of the identified customer needs/problems. As a result of information from analytics engines 130, and considering the master assortment, an updated assortment 350 that adds 20 new, higher utility products may have a utility score of 75% according to engines 330. In addition to adding new, higher utility products, updated assortment 350 also can remove existing lower utility products, for example to create shelf space for the new products.

In one embodiment, engines 330 can provide a list of products identified at 220 and 230 in the master assortment that are not in assortment to be evaluated 340, and the list can be offered in rank of utility as recommendations for addition to updated assortment 350 in order to improve the utility score and ultimately increase sales and improve customer satisfaction by meeting more needs/problems. Sales floor space, product availability and profit can then be considered against the recommendations to make a final determination with respect to whether any of those products will be added to updated assortment 350.

In still other embodiments, engines 330 can consider other factors in determining a utility score of a product or assortment. For example, frequency of purchase probability is a helpful factor that can be considered. A flat screen television may meet many customer needs/problems, but because it is less frequently purchased than other items it may receive a lower score. Another factor can be seasonality (e.g, holidays, warm-weather items, etc.). Still other factors include profit margin, area of floor space, and secondary product need drivers (e.g., boxed dinner kits can meet many customer needs/problems and also themselves require purchase of meat, fresh vegetables, butter, oil, and other ingredients added to that which is provided in the kit), among other factors.

The analysis and scoring can be repeated periodically, for example some time after an assortment is updated in order to check the efficacy of the update, or to consider new customer needs/problems that may arise. This repetition can be carried out on-demand or according to a schedule. It also can be possible, in some circumstances, to compare one retailer's assortment with the assortment of a competitor retailer in the same market. This can provide the retailer with helpful information for, e.g., understanding a change in market share or making product assortment changes in order to drive a change in market share.

Embodiments can be applied to brick-and-mortar, physical retail outlet product assortments or online assortments. Embodiments also can compare the two in order to improve local offerings and make a brick-and-mortar outlet more competitive with online outlets. Embodiments also can be scaled, from evaluating assortments and determining scores at individual retail locations to evaluating scores across sales regions or geographic areas or retailer-wide at an organizational level. This scaling can be applied at different levels and in different ways; for example, it may be helpful to evaluate apparel at a regional level but grocery items store-by-store.

The utility scores, rankings, product suggestions and lists, and other information discussed herein can be presented via a user interface. In one embodiment, the user interface can comprise a buyer portal 360 via which a buyer or purchasing personnel for the retailer can access the information, interact with the system and input commands and place orders for products associated with updated assortment 350. In one embodiment, buyer portal 360 can comprise a computer system associated with the retailer and accessible in a variety of ways, such as via a desktop or laptop computer, tablet device, smartphone device, or other fixed or mobile computing device that is part of or communicatively coupled to a network of the retailer. Buyer portion 360 or a related device can provide output reports of the recommendations and information generated by or used in the systems and methods discussed herein. In one embodiment, these reports can be generated at the direction of engines 330.

Embodiments provide systems and methods for objectively comparing the effectiveness of different product assortments, including in different formats. In contrast with conventional approaches, the systems and methods discussed herein are focused on and driven by meeting customer needs and solving customer problems and look to increase doing so by improving product assortments. Instead of merely looking at past sales and profit data, embodiments of the systems and methods discussed herein identify particular products to proactively add to an available assortment.

In embodiments, the system and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein. Various embodiments of systems, devices, and methods have been described herein.

These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A method of optimizing a retail assortment comprising:
obtaining a mass list of potential products from at least one publicly available source;
collating the mass list into a plurality of customer needs addressable by the potential products;
determining a number of the plurality of customer needs that are addressable by particular ones of the potential products and converting the number for each of the particular potential products into a score for the particular potential product, wherein a high score indicates a particular potential product addresses a high number of the plurality of customer needs;
comparing the particular potential products having high scores with a retail assortment product list for at least one location; and
updating the retail assortment at the at least one location to include at least one of the particular potential products having a high score based on the comparing.

2. The method of claim 1, wherein obtaining the mass list of potential products comprises scraping data from the internet.

3. The method of claim 2, wherein scraping data comprises collecting data selected from the group consisting of: ingredients listed in recipes; supplies listed in recipes; parts listed in instruction sets; supplies listed in instruction sets; supplies listed in patterns.

4. The method of claim 3, wherein the plurality of customer needs comprise at least one of the recipes, the instruction sets or the patterns.

5. The method of claim 1, further comprising:
determining a master product score from the scores of the potential products;
determining a master location score from the retail assortment product list of the at least one location; and
comparing the master product score and the master location score to determine a utility score of the retail assortment product list at the at least one location.

6. The method of claim 5, further comprising:
repeating determining the master location score after updating the retail assortment at the at least one location to include at least one of the particular potential products having a high score; and
repeating comparing the master product score and the master location score to determine a new utility score of the retail assortment product list at the at least one location.

7. The method of claim 6, wherein updating the retail assortment at the at least one location further comprises selecting at least one of the particular potential products having a high score to be added to the retail assortment based on an improvement in the new utility score.

8. A system for optimizing a retail product assortment comprising:
a data scraping and processing engine configured to obtain a mass list of potential products from at least one publicly available source; and
a data processing engine communicatively coupled with the data scraping engine and configured to
collate the mass list into a plurality of customer needs addressable by the potential products,
determine a number of the plurality of customer needs that are addressable by particular ones of the potential products,
convert the number for each of the particular potential products into a score for the particular potential product, wherein a high score indicates a particular potential product addresses a high number of the plurality of customer needs, and
provide an output recommendation to a buyer associated with a retail location to update a product assortment at the retail location to include at least one of the particular potential products having a high score based on comparing the particular potential products having high scores with a product assortment list for the retail location.

9. The system of claim 8, wherein the at least one publicly available source comprises the internet.

10. The system of claim 9, wherein the mass list of potential products comprises ingredients listed in recipes, supplies listed in recipes, parts listed in instruction sets, supplies listed in instruction sets, or supplies listed in patterns.

11. The system of claim 10, wherein the plurality of customer needs comprise the recipes, at least one project associated with the instruction set, or at least one item associated with the pattern.

12. The system of claim 8, wherein the data processing engine is further configured to:
determine a master product score from the scores of the potential products;
determine a master location score from the retail assortment product list of the at least one location; and
compare the master product score and the master location score to determine a utility score of the retail assortment product list at the at least one location.

13. The system of claim 12, wherein the data processing engine is further configured to:
re-determine the master location score after updating the retail assortment at the at least one location to include at least one of the particular potential products having a high score; and
repeat comparing the master product score and the master location score to determine a new utility score of the retail assortment product list at the at least one location.

14. The system of claim 13, wherein the data processing engine is further configured to recommend selecting at least one of the particular potential products having a high score to be added to the retail assortment based on an improvement in the new utility score.

15. The system of claim 8 further comprising a buyer portal configured to receive the output recommendation.

16. The system of claim 15, wherein the buyer portal comprises at least one of a desktop computer, a laptop computer, a tablet computing device, a smartphone device, or a retail computing device.

17. The system of claim 16, wherein the buyer portal is configured to present a user interface, wherein the output recommendation is displayed in the user interface.

18. The system of claim 16, wherein the data processing engine is configured to direct the buyer portal to generate an output report comprising the output recommendation.
